(19) United States
(12) Patent Application Publication
(10) Pub. No.: US 2012/0219115 A1
(43) Pub. Date: Aug. 30, 2012

(54) RADIATION IMAGING APPARATUS AND RADIATION DETECTION SYSTEM

(75) Inventors: Satoshi Okada, Tokyo (JP); Kazumi Nagano, Fujisawa-shi (JP); Keiichi Nomura, Honjo-shi (JP); Yohei Ishida, Honjo-shi (JP); Yoshito Sasaki, Honjo-shi (JP); Tomoaki Ichimura, Kitamoto-shi (JP)

(73) Assignee: CANON KABUSHIKI KAISHA, Tokyo (JP)

(21) Appl. No.: 13/371,547

(22) Filed: Feb. 13, 2012

(30) Foreign Application Priority Data
Feb. 25, 2011 (JP) 2011-040835

(51) Int. Cl. G01N 23/04

(52) U.S. Cl. 378/62

(57) ABSTRACT

A radiation imaging apparatus includes a sensor which is placed in an internal space in the chassis and detects radiation. The apparatus includes a positioning mechanism which moves the sensor in the internal space to determine a position where radiation is detected, so as to change an area where radiation imaging is performed by detecting radiation using the sensor.

### BACKGROUND OF THE INVENTION

1. Field of the Invention

The present invention relates to a radiation imaging apparatus and a radiation detection system.

2. Description of the Related Art

Recently, radiation detection apparatuses have been put into practical use in various applications, and various types of apparatuses including cassette types designed to be lightweight and thin have been proposed. Japanese Patent Laid-Open No. 2006-058366 disclosed a radiation detection apparatus in which a housing, which holds a phosphor for converting X-rays into visible light, photoelectric conversion elements for converting the visible light into electrical signals, and a circuit board, has a slide mechanism. The housing has the slide mechanism movably held on the radiation detection surface side and its rear surface side. The slide mechanism has a sheet-like shape. The housing internally includes rollers which make the sheet slide. The sheet slides to facilitate the insertion of the housing when the operator inserts the housing to an imaging region that is between an object and a bed. Japanese Patent Laid-Open No. 2010-094211 discloses a radiation imaging apparatus in which a solid-state detector for radiation held in a cassette is designed to be movable. The operator can move the solid-state detector from an imaging position to a retreat position where no imaging is performed. When performing imaging operation using an imaging plate which is different in type from the solid-state detector, the operator moves the solid-state detector to the retreat position and places the different type of imaging plate in place of the solid-state detector in the vacant place, thereby allowing to perform imaging operation.

According to the conventional radiation imaging apparatus, when the operator inserts the apparatus to the imaging position between a patient and a bed, the patient feels a sense of discomfort. In addition, it is difficult to adjust the position of the apparatus relative to a region to be imaged. Furthermore, it is not easy to change the area that allows imaging.

### SUMMARY OF THE INVENTION

The present invention provides a radiation imaging apparatus and radiation detection system which allow to perform imaging without making a patient feel any sense of discomfort and facilitate changing an imaging range.

The first aspect of the present invention provides a radiation imaging apparatus including a chassis, a sensor and a positioning mechanism, the sensor is placed in an internal space in the chassis and detects radiation, and the positioning mechanism moves the sensor in the internal space to determine a position where radiation is detected, so as to change an area where radiation imaging is performed by detecting radiation using the sensor.

The second aspect of the present invention provides a radiation imaging apparatus which performs radiation imaging by detecting radiation, the apparatus including a chassis providing an entrance plane which radiation enters, a scintillator fixed to the chassis, a sensor which is placed in an internal space in the chassis and detects light converted by the scintillator and a positioning mechanism which positions the sensor by moving the sensor in the internal space.

The third aspect of the present invention provides a radiation detection system including a radiation source which irradiates an object with radiation; and a radiation imaging apparatus, which detects radiation transmitted through the object, wherein the system is configured to move a position of the radiation source synchronously with movement of the sensor.

Further features of the present invention will become apparent from the following description of exemplary embodiments with reference to the attached drawings.

### BRIEF DESCRIPTION OF THE DRAWINGS

FIGS. 1A to 1D are sectional views for explaining the first embodiment;

FIGS. 2A to 2C are sectional views for explaining the second embodiment;

FIGS. 3A to 3D are sectional views for explaining the third embodiment;

FIG. 4 is a sectional view for explaining the third embodiment;

FIGS. 5A to 5C are sectional views for explaining the fourth embodiment;

FIGS. 6A to 6C are sectional views for explaining the fifth embodiment;

FIG. 7 is a sectional view for explaining the fifth embodiment;

FIGS. 8A to 8C are sectional views for explaining the sixth embodiment;

FIGS. 9A and 9B are sectional views for explaining the sixth embodiment;

FIGS. 10A to 10C are sectional views for explaining the seventh embodiment; and

FIG. 11 is a sectional view for explaining the seventh embodiment.

### DESCRIPTION OF THE EMBODIMENTS

The present invention is directed to a radiation imaging apparatus and a radiation detection system. More specifically, the present invention is directed to a radiation imaging apparatus used for a medical radiation diagnosis apparatus and a nondestructive inspection apparatus. Note that in this specification, the category of radiation includes electromagnetic waves such as X-rays and γ rays.

An embodiment of the present invention will be exemplarily described below with reference to the accompanying drawings. This embodiment features in that in a radiation imaging apparatus including a sensor for detecting radiation and a chassis, a positioning mechanism for the sensor is provided in the chassis to allow the sensor to move in the chassis. The positioning mechanism allows to position a sensor detection area to an imaging region without influencing an object. In addition, applying this apparatus to mammography can reduce the non-detection area at the root portion of the breast.

The chassis is a general term of cases which hold sensors. There are various types of chassis, including a cassette type and a portable type. The chassis has an internal space, in which the sensor is placed.

In this specification, the X-, Y-, and Z-axes along which the sensor moves will be defined as follows. The X-axis and Y-axis directions are directions parallel to a plane on which the sensor detects radiation. A direction perpendicular to the plane on which radiation is detected is the Z-axis direction. A rotation direction is a direction in which the plane on which the sensor detects radiation rotates about the Z-axis. A tilt direction is a tilt direction relative to the plane on which the sensor detects radiation. The positioning mechanism can move the sensor in the X-axis, Y-axis, and Z-axis directions, rotation direction, and tilt direction relative to the plane on which the sensor detects radiation. The positioning mechanism allows the sensor to move at least in the X-axis and Y-axis directions parallel to the plane (X-axis and Y-axis directions) on which the sensor detects radiation.

The main purpose of moving the sensor in the X-axis and Y-axis directions is to move the sensor to an imaging region of an object. The main purpose of moving the sensor in the Z-axis direction is to prevent a reduction in resolution by pressing the sensor against a member on the radiation incident side in the chassis so as to bring it into tight contact with an object. In addition, pressing the sensor against the member on the radiation incident side can reinforce the strength of the chassis. The main purpose of rotating the sensor is to match it with the shape of an imaging region. The main purpose of tilting the sensor is to align it in a direction perpendicular to the irradiation direction.

Moving the sensor to an imaging position using the positioning mechanism can change the imaging area and perform imaging at a proper position. The positioning mechanism can be composed of, for example, a linear guide or a combination of a linear guide and an actuator. A generally known mechanism can be used as this positioning mechanism. The positioning mechanism includes, for example, a driving unit such as a rotary motor or a linear motor, and can be controlled from outside the chassis.

The position of a radiation source which irradiates an object with radiation is made movable synchronously with the movement of the sensor. Making the radiation source movable can properly irradiate the sensor with radiation. The above synchronous moving operation can include at least one of the following operations: (1) making the user operate to adjust the operation by determining the positional relationship between the sensor and the radiation source, and (2) automatically adjusting the operation by detecting the positional relationship between the sensor and the radiation source.

The sensor is a radiation detection sensor including a photoelectric conversion element array for detecting radiation. An example of a sensor for detecting radiation is a sensor composed by arranging a scintillator on a photoelectric conversion element array having photoelectric conversion elements arranged one-dimensionally or two-dimensionally. Another example of a sensor for detecting radiation is a sensor composed by arranging a material for directly converting radiation into an electrical signal on a one-dimensional or two-dimensional array of switch elements. The sensor to be used is not limited to these types. In addition, the photoelectric conversion element to be used includes a MIS type diode, PIN type diode, CMOS, and CCD. However, the photoelectric conversion element to be used is not limited to these types, and includes all types of elements, other than those described above, which convert light into an electrical signal. Examples of the material for the direct conversion type element include amorphous selenium, a Group III-V compound such as GaAs, a Group II-VI compound such as CdTe, HgI₂, and PbI₂.

### First Embodiment

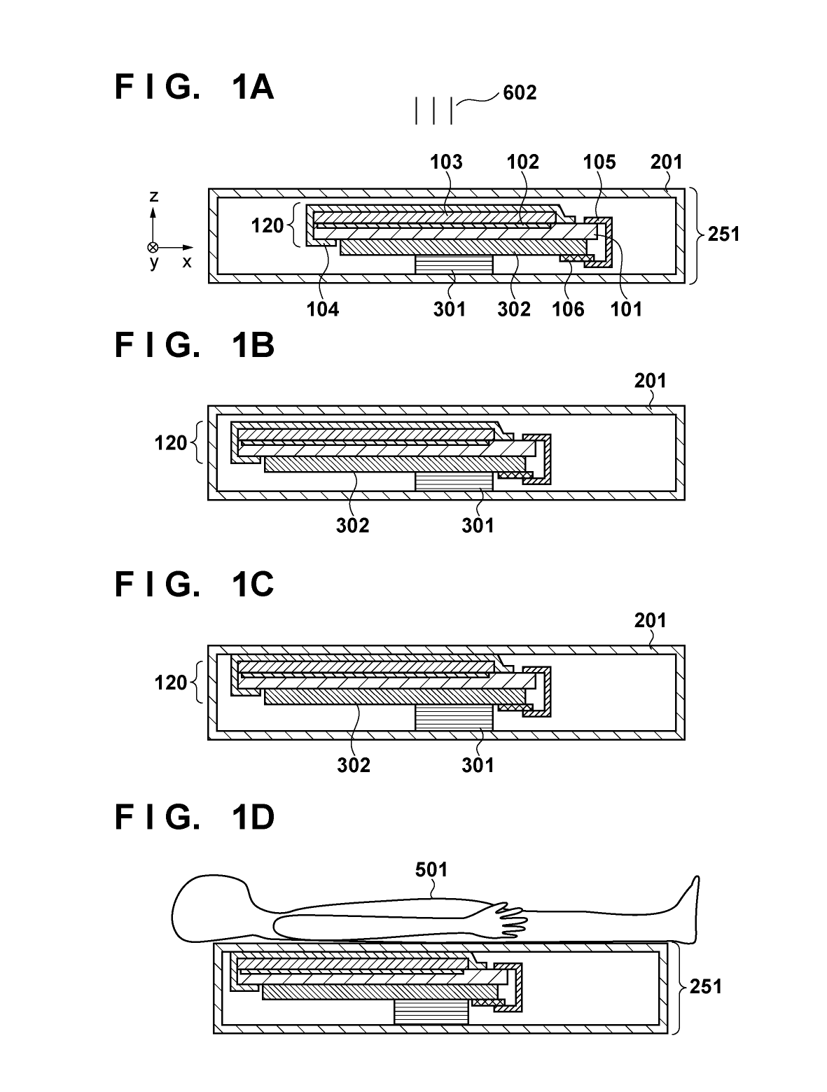

The first embodiment will be exemplarily described with reference to FIGS. 1A to 1D. A sensor 120 is installed in the space in a chassis 201 through a positioning mechanism including a positioning mechanism guide member 301 and a positioning mechanism base portion 302. In this case, a photoelectric conversion element array 102 is formed on the upper surface of a substrate 101, and a scintillator layer 103 is formed on the upper surface of the resultant structure. A scintillator protection layer 104 covers the entire scintillator layer 103. The sensor 120 includes the substrate 101, the photoelectric conversion element array 102, the scintillator layer 103, and the scintillator protection layer 104.

A cassette 251 includes the chassis 201 and the sensor 120 described above. Radiation 602 entering from the upper portion of the drawing is transmitted through the chassis 201 and reaches the sensor. The scintillator layer 103 absorbs the incident radiation and converts it into visible light or the like which the photoelectric conversion element array 102 can detect. The visible light or the like reaches the photoelectric conversion element array 102 and is converted into an electrical signal. The information converted into the electrical signal is transmitted to an electrical signal processing substrate 106 on the back surface of the substrate 101 via a tab 105, and is transmitted to a processing circuit (not shown), thereby obtaining image information.

FIG. 1B shows a state in which the sensor 120 is moved to the left in the drawing. FIG. 1C shows a state in which the sensor is moved upward in the drawing from the state in FIG. 1B. FIG. 1D shows how an object 501 to be examined as an object is placed on the sensor and imaged. The object 501 is placed on the cassette 251. Since the sensor 120 can move in the X-axis, Y-axis, and Z-axis directions in the chassis, it is possible to detect the object at a desired point without moving the object. It is possible to suppress blur in an image by moving the sensor 120 upward so as to bring it close to or into contact with the chassis 201.

The radiation imaging apparatus and the radiation source constitute a radiation detection system. In the radiation detection system, the radiation source is made movable in association with the position of the sensor. A known method is used to move the radiation source. This movement may include rotation. Making the radiation source movable allows to always irradiate the sensor with radiation in the same state even if the sensor is moved to an arbitrary position. This can reduce the risk that image quality will change every time the sensor moves.

An operation procedure in this embodiment will be exemplarily described below. This procedure includes: (1) placing an object to be examined on the cassette; (2) moving the sensor to a desired imaging position, and simultaneously moving the radiation source to a position corresponding to the sensor; (3) obtaining an image by exposing radiation and detecting it with the sensor; and (4) moving the sensor to another desired imaging position when detecting another region, and obtaining an image in the same manner. In the case of a moving image, it is possible to capture a moving image while moving the sensor to a necessary position.

### Second Embodiment

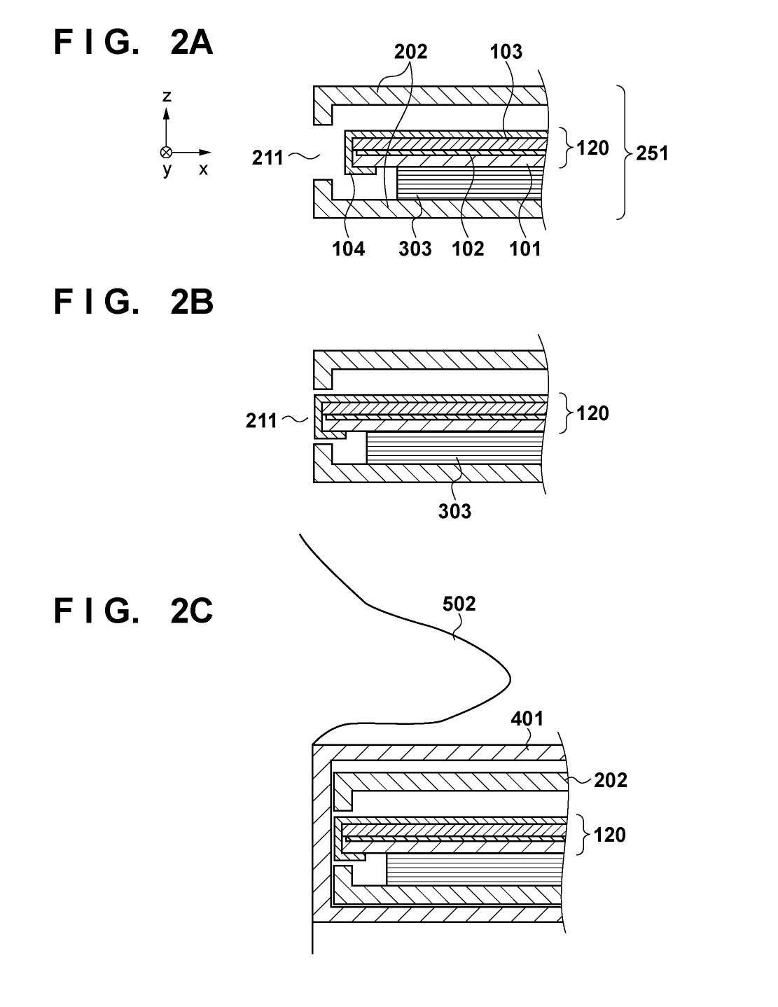

The second embodiment will be exemplarily described with reference to FIGS. 2A to 2C. This embodiment provides the chassis with an opening portion 211. A sensor 120 is mounted inside a chassis 202 with a positioning mechanism 303. A cassette 251 includes the sensor 120 and the positioning mechanism 303. When no capturing is performed, the sensor stays inside the chassis 202, as shown in FIG. 2A. When the cassette 251 is attached/detached or carried, there is little risk that the cassette will be broken by contact with something outside the chassis. When performing capturing image, the positioning mechanism can insert the sensor 120 into the opening portion 211 and move the sensor 120 to the outside of the chassis 202 through the opening portion 211, as shown in FIG. 2B.

FIG. 2C shows an example of how the cassette 251 in this embodiment is applied to mammography. According to the embodiment, it is possible to make the sensor 120 extend through the opening portion of the chassis 202 and abut against the inner side surface of a cassette storing case 401. Bringing the portion of the sensor which detects radiation close to an object allows imaging to be performed up to a range close to the root of a breast 502.

### Third Embodiment

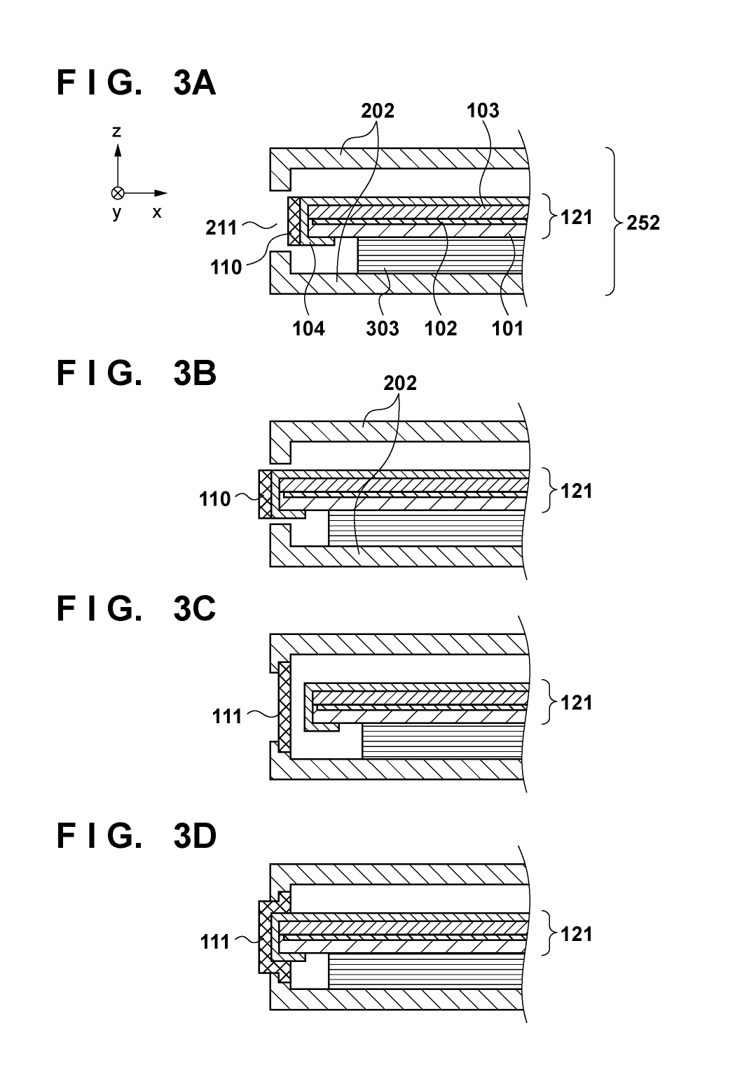

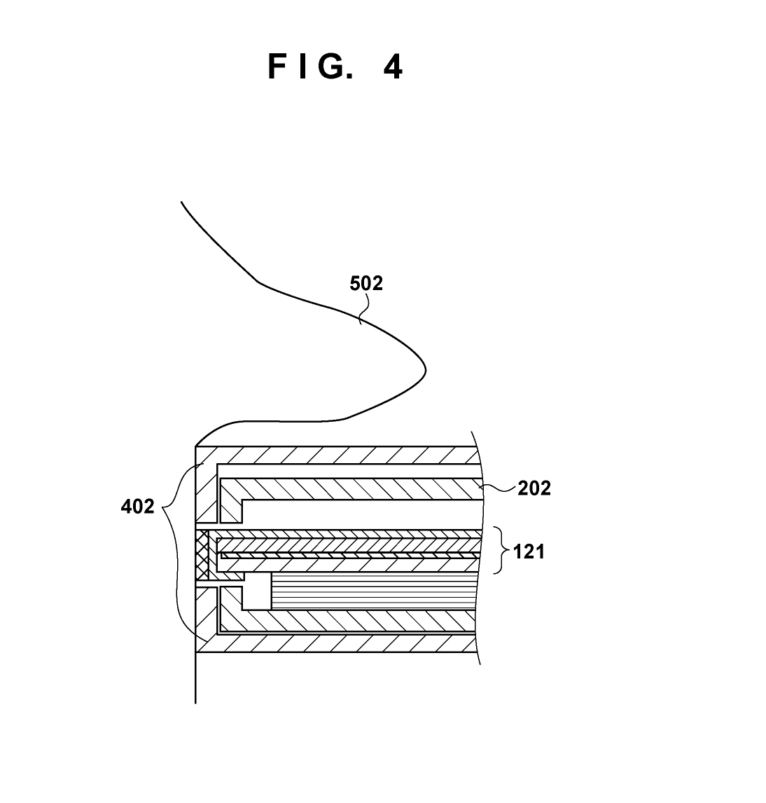

FIGS. 3A to 3D and 4 are views for exemplarily explaining the third embodiment. Unlike the second embodiment, the third embodiment provides a buffer material 110 for an end face of a sensor which is located on the side where it is inserted into the opening portion. The buffer material 110 can protect the sensor from being broken when the sensor end face protrudes from the chassis and strikes on something. The buffer material 110 can be made of any material and can have any shape, such as a resin film, rubber, foaming agent, as long as it can mechanically protect the sensor end face from outside. In addition, the buffer material 110 can be attached to a portion other than the sensor for the purpose of protection.

FIG. 3C shows an example of attaching a buffer material 111 to the chassis so as to cover an opening portion 211 of the chassis. The buffer material may be formed from an elastic member. In this case, as shown in FIG. 3D, the positioning mechanism moves the sensor to abut it against the buffer material. The distal end of the sensor protrudes from the outside of the chassis while stretching the buffer material. The positioning mechanism moves part of the sensor to the outside of the chassis through the opening portion.

As shown in FIG. 4, in the example of applying the radiation imaging apparatus of this embodiment to mammography, an opening portion is also provided in a cassette storing case 402. It is possible to make the sensor further protrude toward the object by providing the opening portion. In the embodiment, the buffer materials 110 and 111 are in direct contact with the object. The buffer materials reduce contamination and contact force on the sensor due to contact with the object. According to the embodiment, it is possible to bring the detection portion of the sensor closer to the object and expand the detection area up to the root of the breast.

Providing an opening portion also in the cassette in this manner can be applied to other embodiments.

### Fourth Embodiment

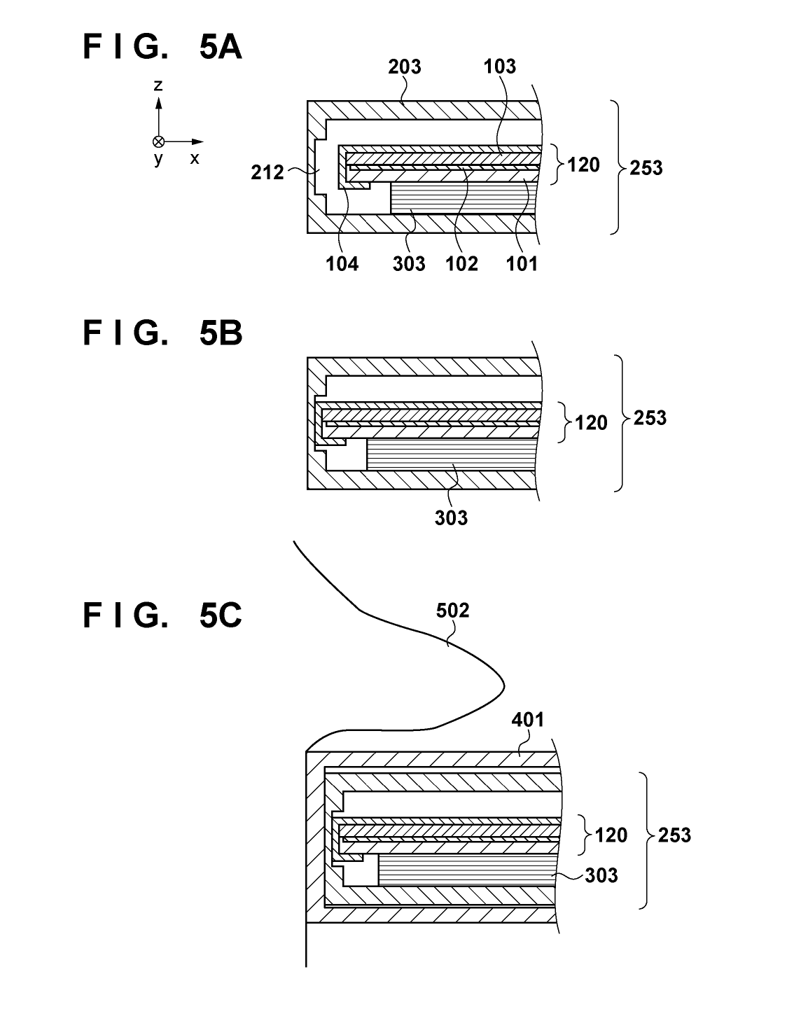

The fourth embodiment will be exemplarily described with reference to FIGS. 5A to 5C. An inner side surface of a chassis 203 is provided with a concave portion 212. In contrast to the second and third embodiments in which the positioning mechanism allows the sensor to move outside the cassette, the fourth embodiment limits the movement of the sensor within the chassis 203.

The concave portion 212 is shaped to allow insertion of the sensor. The concave portion 212 need not be limited to an integral portion formed by indenting an inner side surface of the chassis. It is possible to form such a concave portion by providing an opening portion in the chassis 203 and attaching a member so as to cover the opening portion.

According to this embodiment, since a sensor 120 does not protrude from the outside of the chassis 203, this structure can reduce the risk that the sensor will be broken by contact with something. In addition, according to the embodiment, even when the sensor comes into contact with the object, it is possible to protect from foreign substances such as blood from adhering to the sensor or entering the chassis.

### Fifth Embodiment

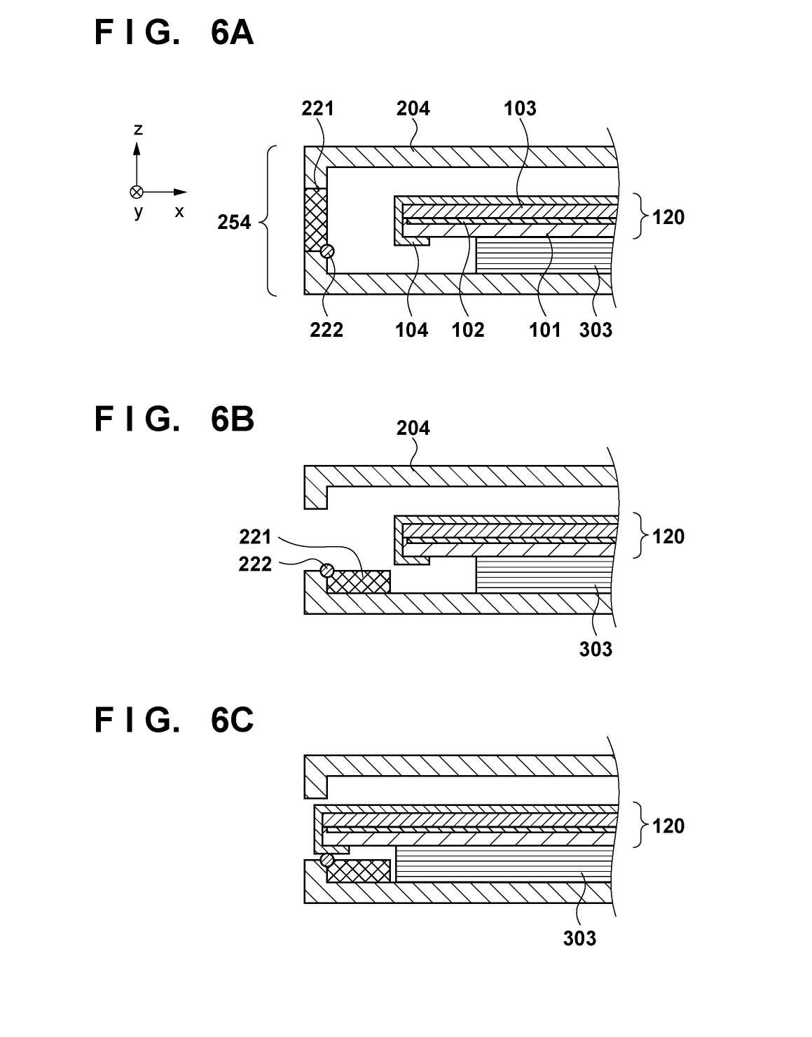

The fifth embodiment will be exemplarily described with reference to FIGS. 6A to 6C. In this case, an opening portion of a chassis 204 is provided an opening/closing lid portion 221. The lid portion 221 can prevent foreign substances from externally entering the chassis. As shown in FIG. 6A, the lid portion 221 may be a type that swings through a hinge 222 to open/close or a shutter type. Various known lid opening/closing mechanisms can be applied to this structure. The material for the lid portion 221 may be the same as or different from that for the chassis 204. A packing may be attached to the contact portion between the lid portion and the chassis to prevent a liquid and the like from entering the chassis.

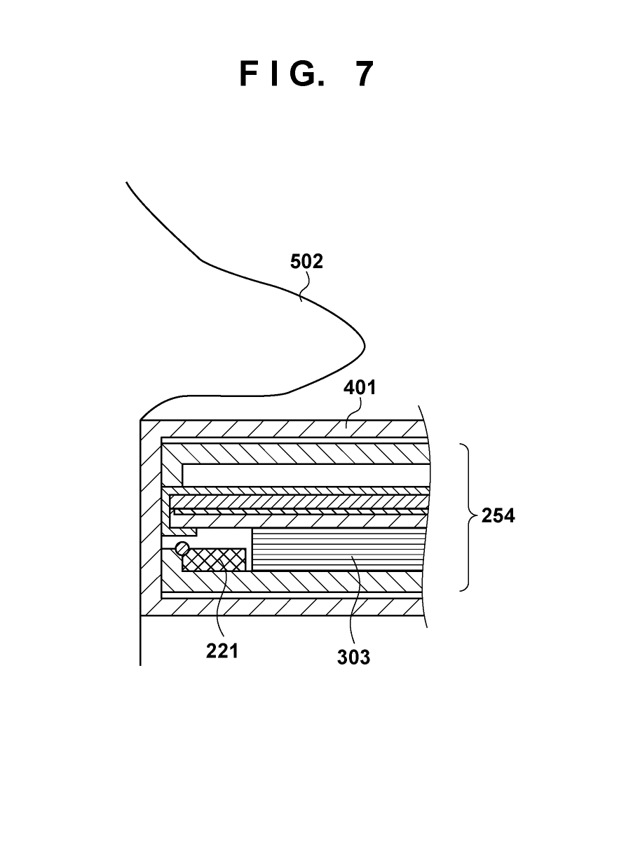

This embodiment accompanying the opening/closing operation of the lid portion will be exemplarily described below. As shown in FIG. 6A, a sensor 120 is placed at a position where the lid portion 221 and the sensor do not interfere with each other. This position will be referred to as a standby position. As shown in FIG. 6B, the lid portion 221 is opened/closed while the sensor is placed at the standby position. In this case, the lid portion 221 tilts to the inside of the chassis to open, and is located on the lower portion of the chassis 204. In this state, as shown in FIG. 6C, the sensor 120 is moved toward an outer side surface of the chassis. FIG. 7 shows an example of mammography. A cassette 254 is stored in a cassette storing case 401. According to this embodiment, when, for example, loading/unloading the cassette 254 into/from the cassette storing case 401, closing the lid portion 221 can protect the sensor from foreign substances such as dust and scattered blood.

### Sixth Embodiment

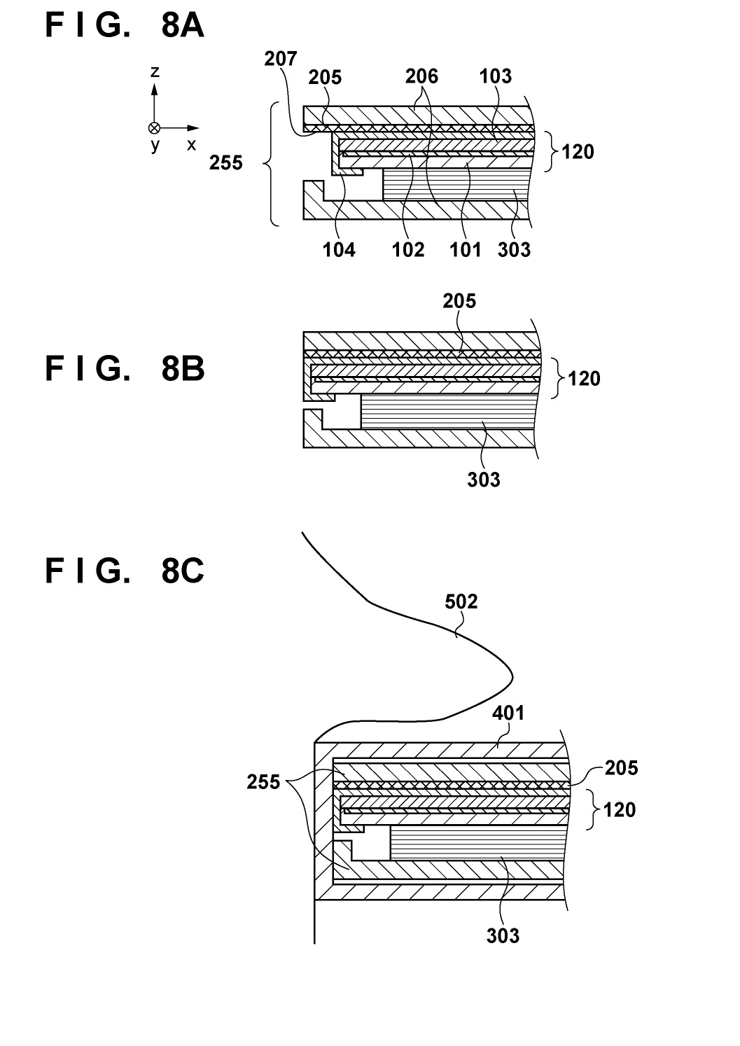

The sixth embodiment will be exemplarily described with reference to FIGS. 8A to 8C. In this case, an inner lower portion of a chassis which is located on the entrance plane side, on which radiation enters, serves as a guide member 207 when positioning a sensor. The guide member 207 may be a flat surface portion of an inner side surface of the chassis. A low-friction sheet 205 for reducing friction may be placed on the flag surface portion. An example of positioning operation using the guide member 207 will be described below.

A positioning mechanism 303 allows to position a sensor 120 while it is in contact with the guide member 207. Since the sensor 120 supports the upper portion of a chassis 206, it is possible to hold the strength of the cassette. This makes it possible to thin the wall of the cassette and implement a thin type cassette.

Placing the low-friction sheet 205 will produce the effect of preventing the development of flaws or breakdown due to friction when the sensor 120 moves. The low-friction sheet 205, a low-friction material such as polytetrafluoroethylene (PTFE: Teflon®) polyacetal (POM), or polyamide (PA) are used. As the low-friction sheet 205, it is possible to use a sheet formed by coating a base with Teflon®. The low-friction sheet may be placed on the radiation detection surface side of the sensor.

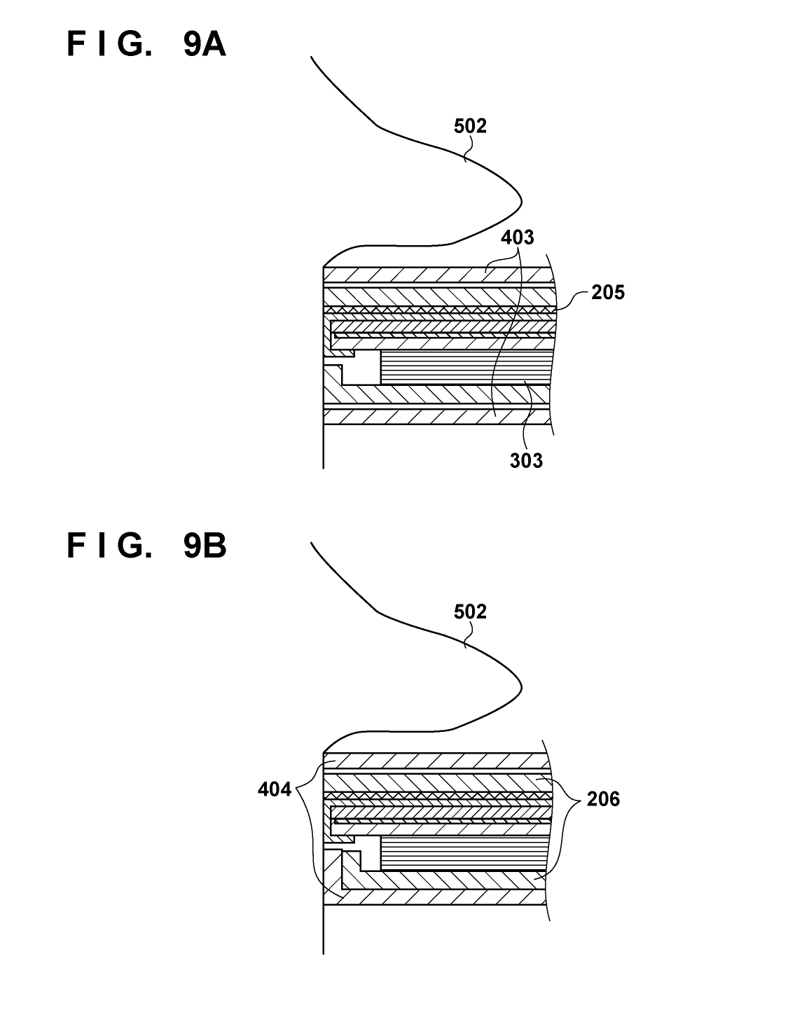

FIG. 8C shows an example of mammography with a cassette 255 being inserted in a cassette storing case 401. FIGS. 9A and 9B show examples in which cassette storing cases 403 and 404 are provided with opening portions such that the sensor 120 abuts directly against the chest of a patient. In the example of FIG. 9B, since the lower portion of the cassette storing case 404 is bent, it is possible to increase the strength of the cassette as compared with the example of FIG. 9A. Applying this embodiment to mammography can expand the image sensing area up to the root of the breast. The embodiment can acquire a clearer image of the breast up to the root.

### Seventh Embodiment

It is possible to fix a scintillator on a chassis and make a photoelectric conversion element array movable. In this case, this produces a merit that the scintillator and the photoelectric conversion element array can be separately maintained. When detecting radiation, the photoelectric conversion element array is strongly pressed against the scintillator to suppress blur in an image.

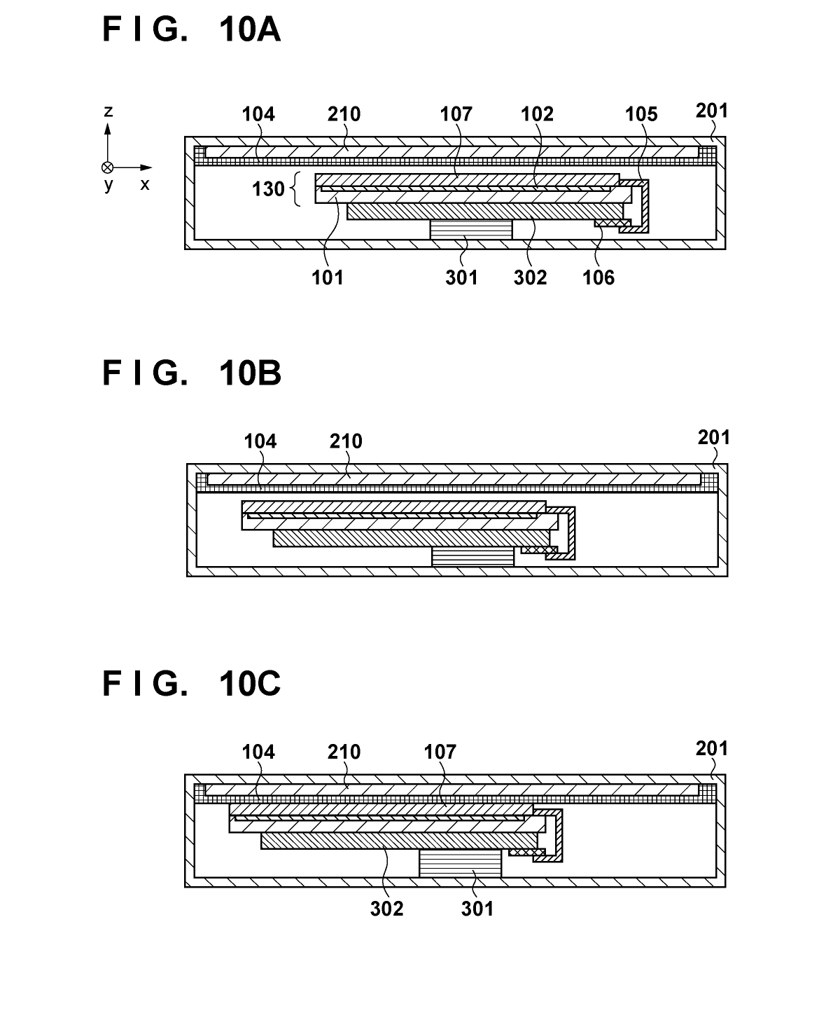

FIGS. 10A to 10C show a embodiment in which a scintillator is fixed to a chassis. In this case, a scintillator 210 is fixed inside the chassis on the entrance plane side where radiation enters a chassis 201. This structure includes a positioning mechanism including a positioning mechanism guide member 301 and a positioning mechanism base portion 302. A photosensor 130 including a glass substrate 101, a photoelectric conversion element array 102, and a fiber optical plate (FOP) 107 is configured to be moved through the positioning mechanism. The operation of this structure will be described next.

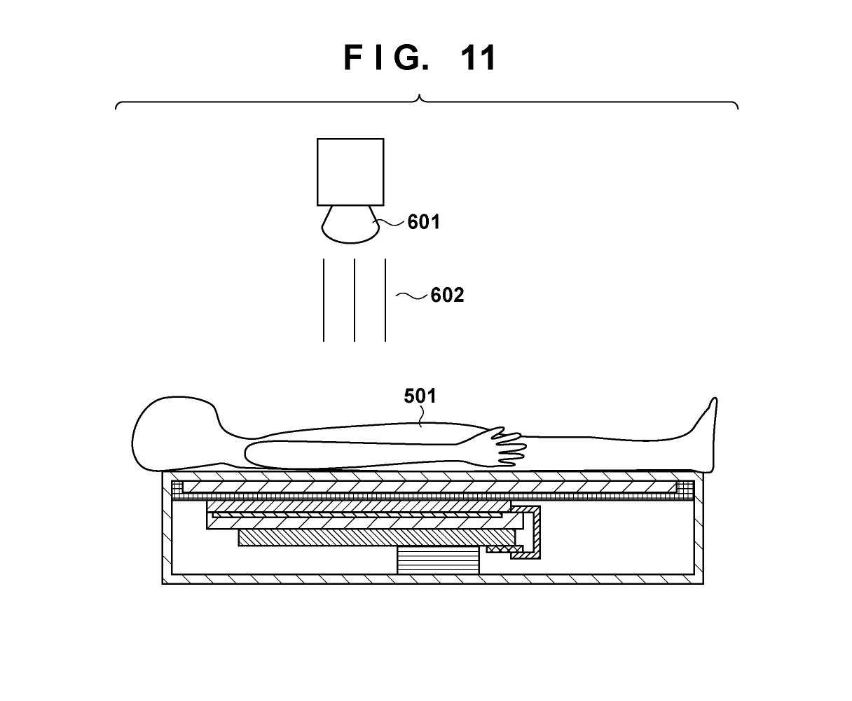

An example of the operation of this embodiment will be described below with reference to FIG. 10B. The positioning mechanism guide member 301 and the positioning mechanism base portion 302 move the photosensor 130 from the position in FIG. 10A toward a plane parallel to the detection surface of the photosensor 130 up to a desired imaging position. The photosensor 130 then moves upward in the drawing to make the FOP 107 come into contact with a scintillator protection layer 104, as shown in FIG. 10C. The purpose of bringing them into contact with each other is to, for example, prevent blur in an image. The thickness of the FOP 107 can protect contact between a tab 105 and the scintillator. Even if the FOP 107 serves to produce a distance between the surface of the sensor and the scintilla or, it is possible to prevent blur. In this state, as shown in FIG. 11, making a radiation source 601 emit radiation 602 can acquire an image signal.

This embodiment allows only the photoelectric conversion element array 102 to be replaced. It is possible to apply various types photoelectric conversion elements depending on the purpose of image capture. When, for example, capturing a moving image of an organ which moves fast such as the heart, it is possible to use a CMOS type photoelectric conversion element. When imaging a large region, it is possible to use a MIS type photoelectric conversion element. It is selectively to use such photoelectric conversion elements in the above manner. When a photoelectric conversion element fails, it is enable to replace only the photoelectric conversion element. Replacing only the photoelectric conversion element is advantageous in terms of cost. It is possible to switch to a further new type of photoelectric conversion element.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-040835, filed Feb. 25, 2011 which is hereby incorporated by reference herein in its entirety.

What is claimed is:

1. A radiation imaging apparatus comprising:
a chassis;
a sensor which is placed in an internal space in said chassis and detects radiation; and
a positioning mechanism which moves said sensor in the internal space to determine a position where radiation is detected, so as to change an area where radiation imaging is performed by detecting radiation using said sensor.

2. The apparatus according to claim 1, wherein said chassis includes an opening portion, and said positioning mechanism is configured to insert said sensor into the opening portion.

3. The apparatus according to claim 2, wherein the opening portion is provided with an opening/closing lid portion.

4. The apparatus according to claim 2, wherein the opening portion is covered by an elastic member, and said positioning mechanism is configured to abut said sensor against the elastic member so as to insert said sensor into the opening portion.

5. The apparatus according to claim 1, wherein said chassis includes a concave portion in an inner side surface thereof, and said positioning mechanism is configured to insert said sensor into the concave portion.

6. The apparatus according to claim 1, wherein said chassis includes a guide member which guides said sensor moved by said positioning mechanism.

7. A radiation imaging apparatus which performs radiation imaging by detecting radiation, the apparatus comprising:
a chassis including an entrance plane which radiation enters;
a scintillator fixed to said chassis;
a sensor which is placed in an internal space in said chassis and detects light converted by said scintillator; and
a positioning mechanism which positions said sensor by moving said sensor in the internal space.

8. The apparatus according to claim 7, wherein said positioning mechanism includes a mechanism which moves said sensor in the internal space at least in a direction parallel to the entrance plane so as to change an area where radiation imaging is performed by said sensor.

9. A radiation detection system comprising:
a radiation source which irradiates an object with radiation; and
a radiation imaging apparatus defined in claim 1, which detects radiation transmitted through the object,
wherein the system is configured to move a position of said radiation source synchronously with movement of said sensor.
